(19) United States
(12) Patent Application Publication
(10) Pub. No.: US 2015/0276104 A1
(43) Pub. Date: Oct. 1, 2015

(54) TUBING JOINT

(71) Applicant: Nordyne LLC, O'Fallon, MO (US)

(72) Inventors: Jie Chen, St. Charles, MO (US); Shixuan Meng, Brentwood, TN (US); Allan J. Reifel, Moscow Mills, MO (US); Russell W. Hoeffken, Millstadt, IL (US); Robert J. Hawk, O'Fallon, MO (US)

(21) Appl. No.: 14/230,735

(22) Filed: Mar. 31, 2014

(51) Int. Cl. F16L 21/06; F16L 13/10

(52) U.S. Cl. CPC F16L 21/06; F16L 13/103

(57) ABSTRACT

A method of joining two tubular sections including applying adhesive to a male end of a first tubular section and fitting the male end to a female end of a second tubular section. A clamp is positioned over the female end of the second tubular section and tightened to apply a circumferential inward force to the female end to reinforce the adhesive in securing the first tubular section to the second tubular section.

### TECHNICAL FIELD

This document pertains generally, but not by way of limitation, to high pressure metal-metal joints and related methods of joining metal tubing.

### BACKGROUND

Heating, Ventilation and Air Conditioning (“HVAC”) systems typically include metal tubing for communicating hot and cold water or refrigerants through the HVAC system. In particular, metal tubing is coiled with the heat exchangers of the HVAC system to facilitate maximum heat transfer between fluids or gases contained within the tubing and surrounding air or fluids while minimizing the overall footprint of the heat exchanger. The tubing conventionally comprises a plurality of copper tubing sections that are joined together to define a continuous fluid path. As the fluids or gases within the tubing are often under high pressures and/or relatively high or low temperatures, the joints between the tubing sections are brazed together to provide a joint capable of withstanding the necessary pressures and temperatures.

The use of aluminum tubing sections in place of copper tubing sections has recently increased. Similarly, copper tubing sections, in particular heat exchanger coils, of existing HVAC systems are frequently replaced with aluminum tubing sections during maintenance or repair. While copper have superior heat conductivity properties, aluminum is less expensive than copper providing a lighter and more cost effective material option. Similarly, unlike copper, aluminum does not develop formicary corrosion, which can cause leakage in the coils. In addition, aluminum can be more easily machined and shaped into configurations that compensate for or overcome the weaker heat conductive properties of aluminum. For example, aluminum can be shaped into micro-channel coils that have higher heat conductivity than conventionally shaped aluminum coils.

However, aluminum-aluminum connections or aluminum-copper connections can be more difficult to correctly braze than copper-copper connections. As the solidus temperature of aluminum is substantially lower than that of copper, the risk of over overheating the aluminum connection and accordingly weakening the connection is substantially higher. In addition, the lower solidus temperature of aluminum limits the filler materials or fluxes that can be used in the brazing of aluminum connections. With certain fluxes, the temperature difference between the liquidus temperature of the flux and the solidus temperature of the aluminum is relatively small providing a very small ideal temperature window for brazing aluminum connections. Similarly, unlike the phosphorus-containing filler materials used for brazing copper connections, the fluxes used to braze aluminum connections can leave a residue following brazing that can cause corrosion or otherwise weaken the brazed connection.

Accordingly, substantial care can be needed for brazing aluminum-aluminum and aluminum-copper connections, slowing the production of the aluminum components as well as increasing the cost. In addition, the high level of skill required as well as the unique equipment required to properly braze aluminum connections makes field installation of new HVAC systems or maintenance of existing HVAC systems particularly tedious.

### Overview

The present inventors have recognized, among other things, that a problem to be solved can include efficiently forming secure joints between metal tubing sections that are capable of withstanding high pressures. In an example, the present subject matter can provide a solution to this problem such as by adhering a male end of a first tubing section within a female end of a second tubing section with an adhesive. A clamp can be tightened over the overlapping tubing section between the first and second tubing sections to reinforce the joint between the first and second tubing sections. The combination of the adhesive and clamp can provide a secure joint between the first and second tubing sections capable of withstanding pressures equal to and even surpassing brazed joints. A joint secured by the combination of adhesive and clamp has been found to surprisingly withstand pressures that burst the tubing section itself. In addition, as the adhesive and clamp can be installed with minimal tools and expertise, tubing sections having difficult to braze materials, such as aluminum, can be joined with an equivalent or superior joint in less time and with less difficulty.

In an example, a method for joining disparate tubing sections can include providing a first tubing section including a male end and providing a second tubing section including a female end. The method can also include applying an adhesive compound to at least one of an exterior surface of the male end of the first tubing section and an interior surface of the female end of the second tubing section. The method can also include inserting the male end of the first tubing section into the female end of the second tubing section to form an overlapping tubing section, wherein the adhesive compound is compressed between the male end of the first tubing section and the female end of the tubing section. The method can also include positioning a clamp over the female end such that the clamp is positioned within the overlapping tubing section when the male end of the first tubing section is inserted into the female end of the second tubing section. Finally, the method can include tightening the clamp to apply an inward circumferential force to the overlapping tubing section.

In an example, a system for joining disparate tubing sections can include a first tubing section including a male end; a tubing section including a female end; and a clamp. The male end of the first tubing section can be configured to be inserted into the female end of the second tubing section to form an overlapping tubing section. An adhesive compound can be applied to at least one of an exterior surface of the male end of the first tubing section and an interior surface of the female end of the second tubing section. The clamp can be positioned over the female end such that the clamp is positioned within the overlapping tubing section when the male end of the first tubing section is inserted into the female end of the second tubing section. The clamp can be tightened to apply an inward circumferential force to the overlapping tubing section.

This overview is intended to provide an overview of subject matter of the present patent application. It is not intended to provide an exclusive or exhaustive explanation of the present subject matter. The detailed description is included to provide further information about the present patent application.

### BRIEF DESCRIPTION OF THE DRAWINGS

In the drawings, which are not necessarily drawn to scale, like numerals may describe similar components in different views. Like numerals including different letter suffixes may represent different instances of similar components. The drawings illustrate generally, by way of example, but not by way of limitation, various embodiments discussed in the present document.

FIG. 1 is a perspective view of a tubing joint according to an example.

FIG. 2 is a perspective view of a first tubing section fitted to a second tubing section according to an example.

FIG. 3 is a side view of a first tubing section fitted to a second tubing section according to an example.

FIG. 4 is a cross-sectional view of the first and second tubing sections depicted in FIG. 3 along indicated axis A.

FIG. 5 is an exploded perspective view of a first tubing section, a second tubing section and a clamp according to an example.

FIG. 6 is a partially exploded perspective view of a first tubing section, a second tubing section and a clamp according to an example, wherein the clamp is fitted to the second tubing section.

FIG. 7 is a partially exploded perspective view of a first tubing section, a second tubing section and a clamp according to an example, wherein an adhesive compound has been applied to the first tubing section.

FIG. 8 is a perspective view of a first tubing section, a second tubing section and a clamp according to an example, wherein when the first tubing section is fitted within the second tubing section prior to the tightening of the clamp.

FIG. 9 is a perspective view of a tubing joint according to an example.

FIG. 10 is an axial view of a tubing joint according to an example.

FIG. 11 is a side view of a tubing joint according to an example.

FIG. 12 is a cross-sectional view of the tubing joint depicted in FIG. 11 along indicated axis B.

FIG. 13 is cross-sectional view of indicated section C of the tubing joint depicted in FIG. 12.

FIG. 14 is an exploded perspective view of a tubing section, a refrigeration service valve tubing section and a clamp according to an example.

FIG. 15 is a perspective view of a tubing joint for a refrigeration service valve to an example.

FIG. 16 is a perspective view of indicated section D of the tubing joint depicted in FIG. 15.

### DETAILED DESCRIPTION

In an example, the present subject matter relates to a tubular joint 20 formed by inserting a male end 28 of a first tubing section 24 into a female end 32 of a second tubing section 24. An adhesive compound 36 is applied to the overlapping tubing section and a clamp 26 is used to apply an inward circumferential force to the overlapping tubing section. The clamping of the clamp 26 over the adhesively joined overlapping tubing section was found to provide superior joint than either adhering the joint with an adhesive compound or clamping the joint alone. In particular, the clamping reinforces the adhesive compound such that leaks are less likely at pressures nearing the burst pressure of the joint when adhered together with adhesive compounds. A similar advantage is that the clamp 26 can be positioned and tightened by rotating a nut 41 on a threaded screw 40, or vice versa, to draw the end portions 42 of the clamp 26 together. This arrangement allows the clamp 26 to be positioned and tightened without the aid of specialized tools or advanced training The simplicity of the installation increases the amount of the installation of an HVAC system that can be performed on site rather than at the factory.

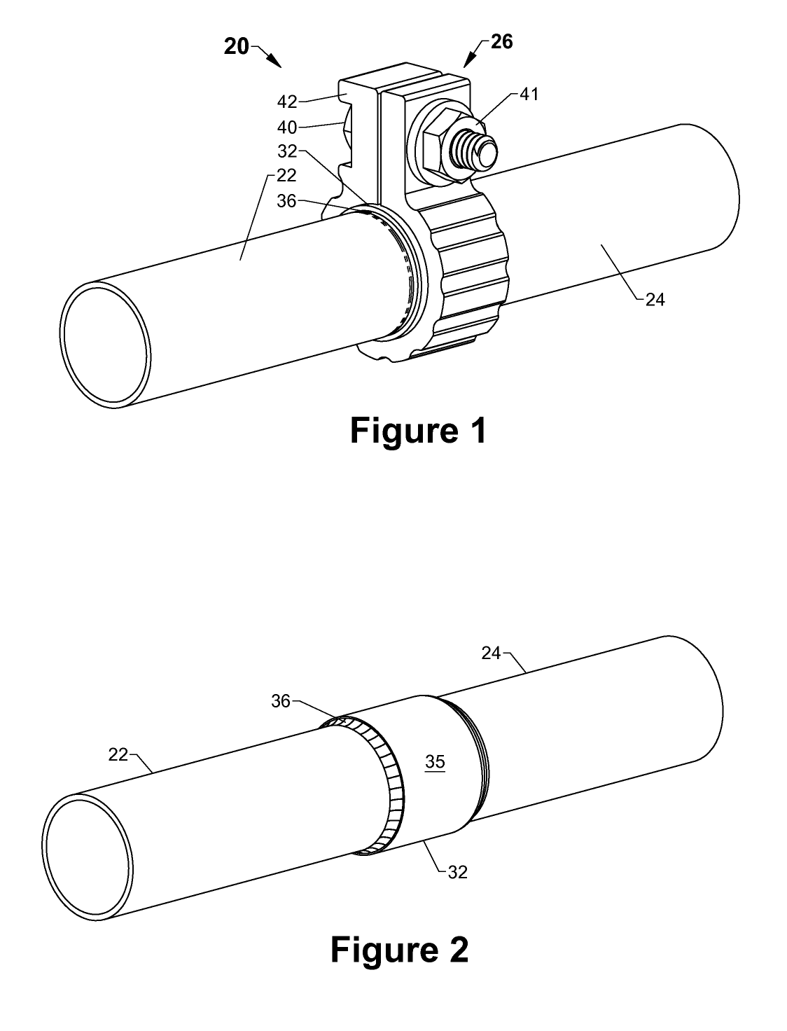

As depicted in FIGS. 1, 5-8, a tubular joint 20, according to an example, includes a first tubing section 22, a second tubing section 24 and a clamp 26. The first tubing section 22 includes a male end 28 including an outer surface 30. The second tubing section 24 includes a female end 32 including an inner surface 34 and an outer surface 35. In an example, the inner diameter of the female end 32 of the second tubing section 24 is sized to approximate the outer diameter of the male end 28 of the first tubing section 22. In an example, inner diameter of the female end 32 is sized to define a gap between the inner surface 34 of the female end 32 and the outer surface 30 of the male end 28 between about 0.001 inches and 0.0250 inches. In this configuration, the male end 28 of the first tubing section 22 can be inserted into the female end 32 joining the first tubing section 22 to the second tubing section 24. The insertion of the male end 28 into the female end 32 defines an overlapping tubing section. In an example, the length of the overlapping tubing section between about 95% to about 125% of outer diameter of the tubing section 22, 24. In other examples, the overlapping tubing section is between about 95% to about 115% of the outer diameter of tubing sections 22, 24.

As depicted in FIGS. 4, 7 and 12-13, adhesive compound 36 is applied to the outer surface 30 of the male end 28 such that the adhesive compound 36 is compressed between the outer surface 30 of the male end 28 and the inner surface 34 of the female end 32 in at least the overlapping tubing section. In an example, the adhesive compound 36 is applied alternatively or also applied to the inner surface 34 of the second tubing section 24. The adhesive compound 36 can include, but is not limited to anaerobic polymer resins, contact cements, fiber reinforced sealants, duct liner adhesives, lagging adhesives and other adhesives and/or sealants for providing a fluid tight seal between the male end 28 of the first tubing section 22 and the female end 32 of the second tubing section 24. In an example, the adhesive compound 36 can maintain a fluid type seal unaided up to pressures about 1200 psig. In an example, the gap between the inner surface 34 of the female end 32 and the outer surface 30 of the male end 28 is sized to receive a quantity of the adhesive compound 36 without pushing an excessive amount of the adhesive compound 36 out of the overlapping tubing section. In certain examples, sufficient adhesive compound 36 is retained between the outer surface 30 and the inner surface 34 is sufficiently to coat the entire outer surface 30. In an example, the gap can be oversized such than an excess amount of adhesive compound 36 is retained in the gap such that the tightening of the clamp 26 can reduce the width of the gap during tightening while retaining sufficient adhesive compound 36 within the gap.

In an example, the outer surface 30 of the male end 28 can be textured to provide improved engagement of the adhesive compound 36 and to the inner surface 34 of the female end 32. In certain examples, the inner surface 34 of the female end 32 is alternatively or can also be textured to improve engagement of the adhesive compound 36 and to the outer surface 30 of the male end 28. In an example, the outer surface 30 of the male end 28 and the inner surface 34 of the female end 32 can be treated or cleaned to improve engagement of the adhesive compound 36 to the outer surface 30 of the male end 28 and the inner surface 34 of the female end 32. In an example, the outer surface 30 of the male end 28 includes at least one protrusion for engaging a corresponding notch in the inner surface 34 of the female end 32 to improve retention of the first tubing section 22 to the second tubing section 24. In a configuration, the inner surface 34 of the female end 32 alternatively or also includes at least one protrusion for engaging a corresponding notch in the outer surface 30 of the male end 28.

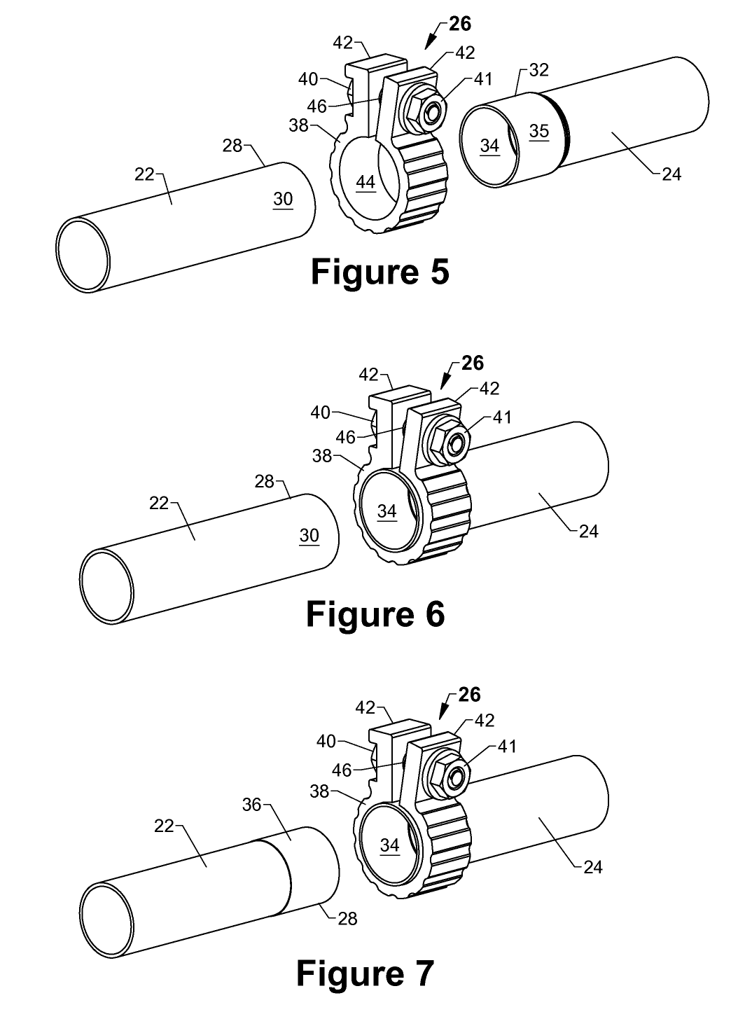

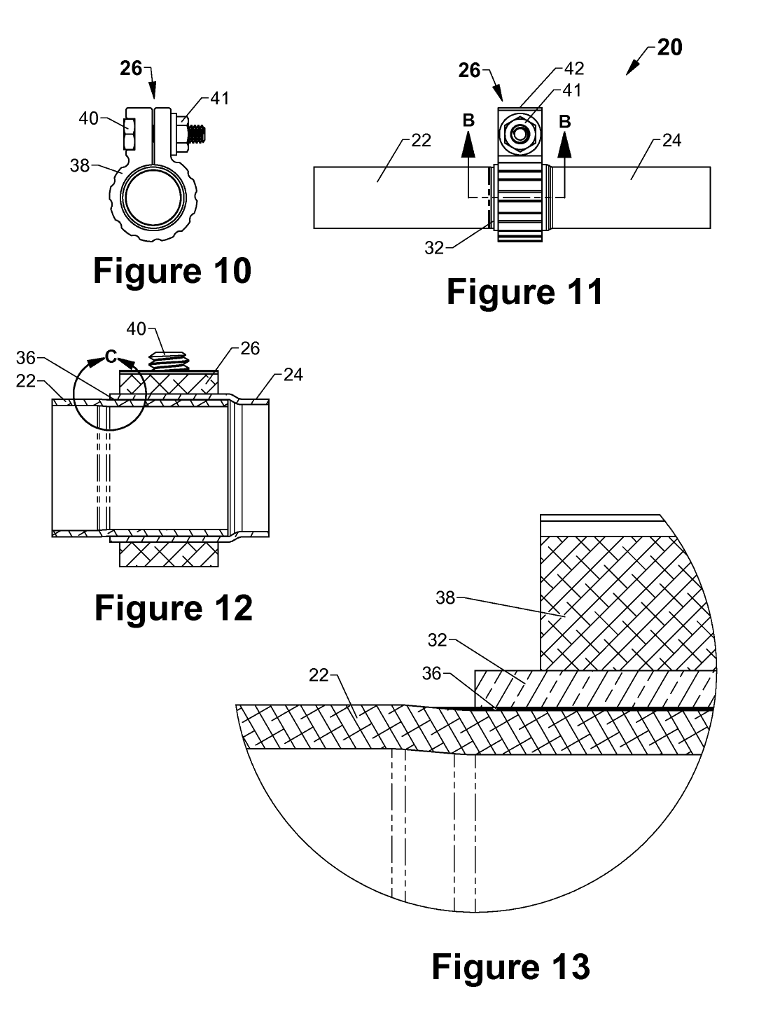

As depicted in FIGS. 5-13, in an example, the clamp 26 includes a bendable leaf 38 and a threaded screw 40. The bendable leaf 38 is shaped in a generally tubular configuration and includes a pair of end portions 42, each end portion 42 defining a threaded bore hole 46 for receiving the threaded screw 40 to operably connect the end portions 42. In an example, the bore hole 46 is smooth and the clamp 26 also includes a threaded nut 41 for engaging the threaded screw 40 to assist in the tightening of the clamp 26. In this configuration, the threaded nut 41 can be rotated on the threaded nut 41 to pull the end portions 42 together. The bendable leaf 38 also includes an inner surface 44 engagable to the outer surface 35 of the female end 32. In an example, a liner including, but not limited to nylon tape or a shrink tube can be positioned between the inner surface 44 of the clamp 26 and outer surface 35 of the female end 32.

In operation, the threaded screw 40 or the threaded nut 41 is rotatable in a first direction to draw the end portions 42 together and reduce an inner diameter of the bendable leaf 38. As depicted in FIGS. 6-7, the clamp 26 is positionable over the female end 32 of the second tubing section 24 such that the clamp 26 is positioned over the overlapping tubing section when the male end 28 of the first tubing section 22 is inserted into the female end 32. As depicted 8-9 and 12-13, rotating the threaded screw 40 or threaded nut 41 to tighten the clamp 26 applies an inward circumferential force to the overlapping tubing section compressing the applied adhesive 36 and reinforcing the joint between the first tubing section 22 and the second tubing section 24. In an example, the inward circumferential force can be determined by the torque applied to tighten the threaded screw 40 or threaded nut 41 and/or the final distance between end portions 42 as the threaded screw 40 or threaded nut 41 is tightened. In certain embodiments, the clamp 26 is tightened such that the end portions 42 are less than about 0.032 inches apart. The necessary circumferential force necessary can vary depending on the thickness of the tubing sections 22, 24; the diameter of the tubing sections 22, 24; the length of the overlapping tubing section; the thickness of the adhesive compound layer 36; the viscosity of the adhesive compound 36; the relative positioning of the tubing sections 22, 24 relative to pressure sources; the upstream or downstream refrigeration service valve or other factors. In this configuration, the inner diameter of the clamp 26 when the end portions 42 are less than about 0.032 inches apart closely approximates the outer diameter of the outer diameter of the tubing sections 22, 24 to provide sufficient inward circumferential force without over compressing the overlapping tubing section and forcing the adhesive out of the overlapping tubing section when the male end 28 is inserted into the female end 32.

As depicted in FIGS. 4 and 12-13, in an example, the inner surface 44 includes a smooth surface. In this configuration, the inner surface 44 of the clamp 26 uniformly applies the inward circumferential force. In an example, the inner surface 44 includes a ribbed surface. In this configuration, the tightening the clamp 26 to apply the inward circumferential force crimps the female end 32 further reinforcing the joint between the first tubing section 22 and the second tubing section 24.

In an example, the first tubing section 22 and the second tubing section 24 include a metal, including, but not limited to aluminum, brass, copper, stainless steel, steel, alloys thereof and combinations thereof. In an example, the clamp 26 includes a rigid material, including, but not limited to aluminum, steel, nylon, polyvinyl chloride, high density polyethylene, low density polyethylene and other rigid materials. In certain examples, the clamp 26 is anodized or coated to prevent corrosion between the female end 32 of the second tubing section 24 and the inner surface 44 of the clamp 26.

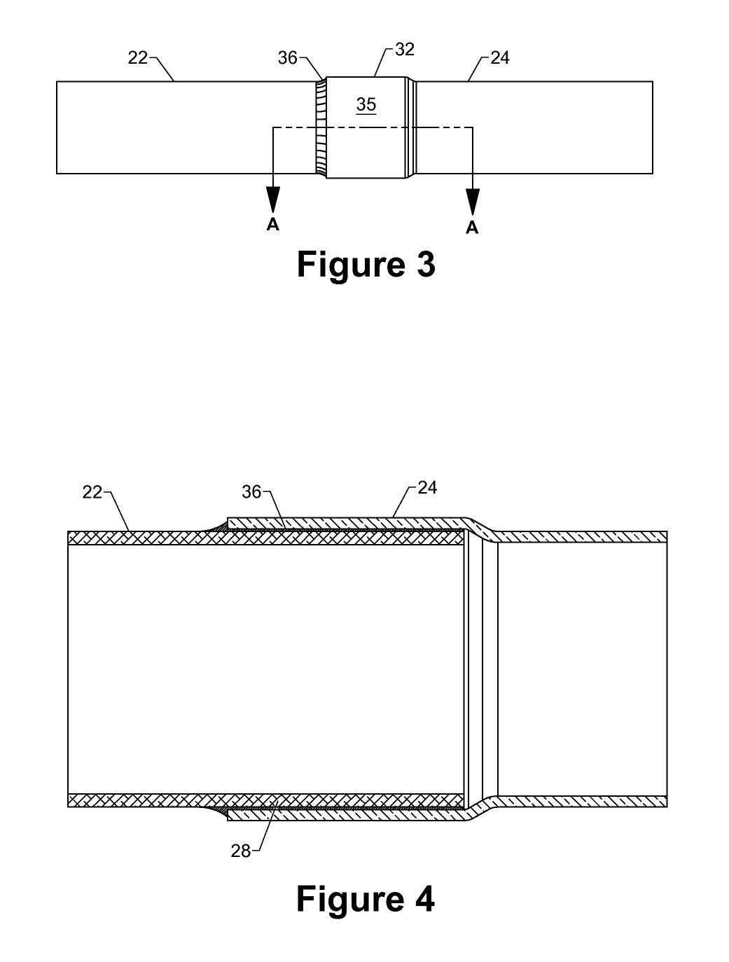

As depicted in FIGS. 2-9, a method for forming a tubular joint 20 includes providing a first tubing section 22 and a second tubing section 24. As depicted in FIGS. 2-4, the second tubing section 24 includes a female end 32 having an inner diameter sized to receive a male end 28 of the first tubing section 22 as illustrated in FIG. 4.

As depicted in FIGS. 5-6, the method further includes positioning a clamp 26 over the female end 32 of the second tubing section 24. An inner surface 44 of the clamp 26 is engaged an outer surface 35 of the female end 32 of the second tubing section 24 as depicted in FIG. 6.

As depicted in FIG. 7, the method further includes applying an adhesive 36 to at least one of the outer surface 30 of the male end 28, the inner surface 34 of the female end 32 or combinations thereof.

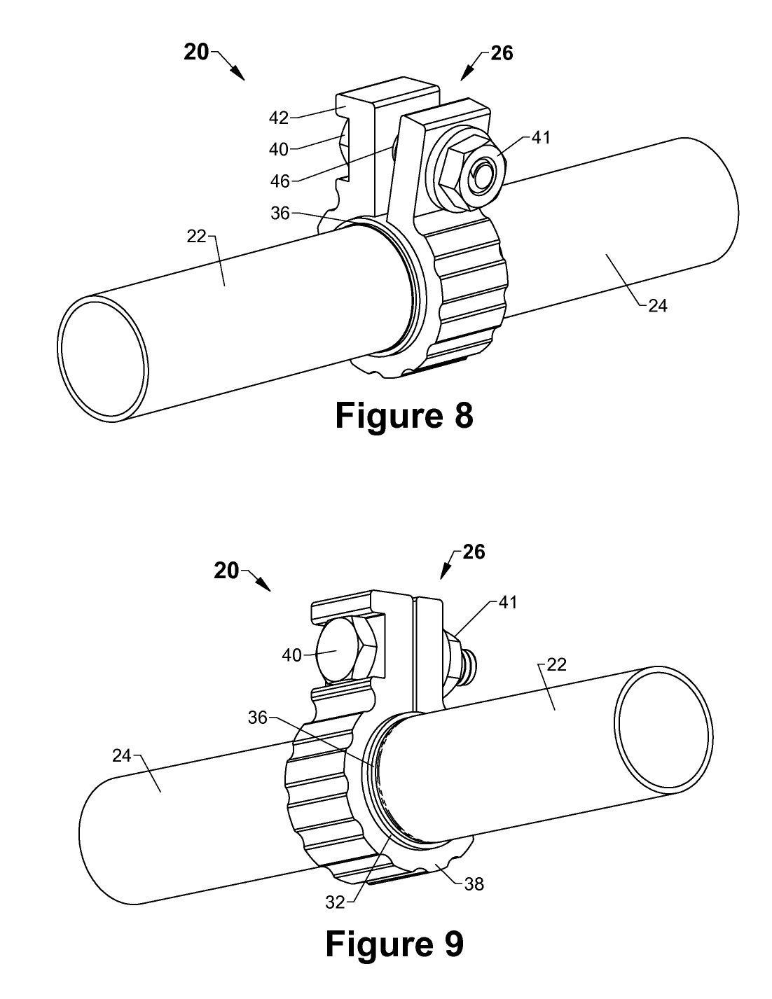

As depicted in FIG. 8, the method further includes inserting male end 28 of the first tubing section 22 into the female end 32 of the second tubing section 24. The adhesive 36 is positioned between the inner surface 34 of the female end 32 and the outer surface 30 of the male end 28 as depicted in FIG. 4.

As depicted in FIGS. 1 and 9, the method further includes tightening the clamp 26 to apply a circumferential inward force to the female end 32, securing the male end 28 of the first tubing section 22 within the female end 32 of the second tubing section 24.

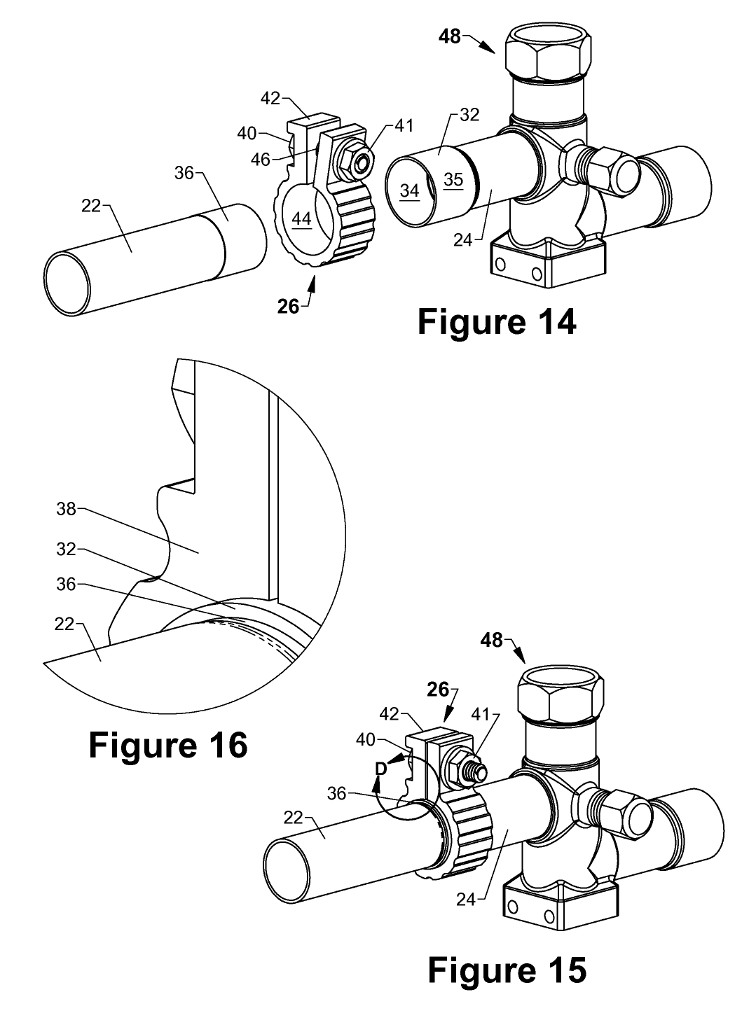

As depicted in FIGS. 14-16, the second tubing section 24 can include an adapter for a refrigeration service valve 48. In certain examples, the second tubing section 24 can alternatively include, but are not limited to, elbow fittings, t-fittings, refrigeration line dryers, refrigeration coils, compressors, reversing valves, accumulators, pressure switches or flow meters.

In an example, an HVAC system can be fitted with at least one tubular joint 20 including a first tubing section 22 having a male end 28 and a second tubing section 24 having a female end 32, in which the male end 28 of the first tubing section 22 is inserted into the female end 32 to form an overlapping tubing section. Prior to insertion, an adhesive compound 36 is applied to an outer surface 30 of the male end 28 and/or an inner surface 34 of the female end 32. A clamp 26 configured to be positioned over the overlapping tubing section can be tightened to apply an inward circumferential force to the overlapping tubing section to secure the first tubing section 22 to the second tubing section 24. The tubular joint 20 is configured to withstand high pressures of gases and fluids used in HVAC systems. The combination of adhesive compound 36 and the clamp 26 reduce the likelihood of the tubular joint 20 bursting or leaking.

Each of these non-limiting examples can stand on its own, or can be combined in any permutation or combination with any one or more of the other examples.

The above detailed description includes references to the accompanying drawings, which form a part of the detailed description. The drawings show, by way of illustration, specific embodiments can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the described subject matter should be determined with reference to the appended claims, along with the full scope of equivalents to which such claims are entitled.

What is claimed:

1. A method for joining tubing sections, comprising:
providing a first tubing section including a male end;
providing a second tubing section including a female end;
applying an adhesive compound to at least one of an exterior surface of the male end of the first tubing section and an interior surface of the female end of the second tubing section;
inserting the male end of the first tubing section into the female end of the second tubing section to form an overlapping tubing section, wherein the adhesive compound is compressed between the male end of the first tubing section and the female end of the tubing section;
positioning a clamp over the female end such that the clamp is positioned within the overlapping tubing section when the male end of the first tubing section is inserted into the female end of the second tubing section; and
tightening the clamp to apply an inward circumferential force to the overlapping tubing section.

2. The method of claim 1, wherein at least one of the first tubing section and the second tubing section comprises aluminum.

3. The method of claim 1, further including positioning a liner between an inner surface of the clamp and the outer surface of the female end.

4. The method of claim 1, wherein the second end of the second tubing section is sized such than an inner diameter of the second end of the second end approximates an outer diameter of the first end of the first tubing section.

5. The method of claim 1, the clamp comprises a tubular clamp including two end portions connectable by a threaded screw.

6. The method of claim 5, further comprising:
rotating a threaded nut on the threaded screw to draw the two end portions to tighten the clamp and apply the inward circumferential force to the overlapping tubing section.

7. The method of claim 5, wherein the clamp defines a smooth interior surface that uniformly engages an outer surface of the female end of the second tubing section.

8. The method of claim 1, wherein the clamp comprises a coated metal to prevent corrosion.

9. The method of claim 8, wherein the clamp comprises anodized aluminum.

10. A system for joining tubing sections, comprising:
a first tubing section including a male end;
a second tubing section including a female end, the male end of the first tubing section configured to be inserted into the female end of the second tubing section to form an overlapping tubing section;
an adhesive compound, wherein the adhesive compound is applied to at least one of an exterior surface of the male end of the first tubing section and an interior surface of the female end of the second tubing section; and
a clamp configured to be positioned over the overlapping tubing section and tightened to apply an inward circumferential force to the overlapping tubing section.

11. The system of claim 10, wherein at least one of the first tubing section and the second tubing section comprises aluminum.

12. The system of claim 10, the system further including a liner between an inner surface of the clamp and the outer surface of the female end.

13. The system of claim 10, wherein the second end of the second tubing section is enlarged such than an inner diameter of the second end of the second end approximates an outer diameter of the first end of the first tubing section.

14. The system of claim 10, the clamp comprises a tubular clamp including two end portions connectable by a threaded screw.

15. The system of claim 14, wherein a threaded nut is positionable on the threaded screw and rotatable to draw the two end portions to tighten the clamp and apply the inward circumferential force to the overlapping tubing section.

16. The system of claim 14, wherein the clamp defines a smooth interior surface for uniformly engaging an outer surface of the female end of the second tubing section.

17. The system of claim 10, wherein the clamp comprises a coated metal to prevent corrosion.

18. The system of claim 17, wherein the clamp comprises anodized aluminum.
